(19) United States
(12) Patent Application Publication
(10) Pub. No.: US 2026/0106306 A1
(43) Pub. Date: Apr. 16, 2026

(54) BATTERY MODULE AND BATTERY PACK COMPRISING SAME

(71) Applicant: SK ON CO., LTD., Seoul (KR)

(72) Inventors: Tak-Kyung YOO, Daejeon (KR); Seung-Hun LEE, Daejeon (KR); Yang-Kyu CHOI, Daejeon (KR)

(21) Appl. No.: 19/115,793

(22) PCT Filed: Jun. 27, 2023
(86) PCT No.: PCT/KR2023/008965

§ 371 Date: Mar. 27, 2025

(30) Foreign Application Priority Data
Oct. 28, 2022 (KR) 10-2022-0141411

(51) Int. Cl. H01M 50/291; H01M 10/613; H01M 10/6557; H01M 50/211; H01M 50/242; H01M 50/244; H01M 50/258; H01M 50/507

(52) U.S. Cl. CPC H01M 50/291; H01M 10/613; H01M 10/6557; H01M 50/211; H01M 50/242; H01M 50/244; H01M 50/258; H01M 50/507

(57) ABSTRACT

Provided is a battery module comprising: a plurality of sub-modules arranged along a first direction; one or more connecting members disposed between the plurality of sub-modules, wherein at least one of the plurality of sub-modules is disposed along the first direction; and a housing having an internal space in which the plurality of cell stacks are accommodated, wherein the plurality of cell stacks each include a plurality of battery cells stacked in a second direction perpendicular to the first direction.

### DESCRIPTION

This application is a national stage application of PCT/KR2023/008965 filed on Jun. 27, 2023, which claims priority of Korean patent application number 10-2022-0141411 filed on Oct. 28, 2022. The disclosure of each of the foregoing applications is incorporated herein by reference in its entirety.

### TECHNICAL FIELD

The present disclosure relates to a battery module and a battery pack comprising same.

### BACKGROUND ART

Secondary batteries (battery cells) are attracting significant attention as power sources for various mobile devices and electric vehicles because they are convenient, in that they may be charged and discharged, unlike primary batteries.

Battery modules are modularized by electrically connecting a plurality of battery cells due to the need for high output and high capacity, and a battery pack including such battery modules in plural may be applied to devices requiring high power, such as electric vehicles.

For example, as illustrated in FIGS. 1 and 2, a battery pack BP may include a plurality of battery modules BM. FIG. 1 is an example diagram of a conventional battery pack. FIG. 2 is a schematic cross-sectional view taken along line I-I′ of FIG. 1. As illustrated in FIG. 2, when the plurality of battery modules BM are disposed inside the battery pack BP, a void (so-called dead space (DS) ) may be formed between one battery module BM and another battery module BM. Even if the battery modules BM are designed to be disposed in close contact with each other, such dead space (DS) may occur due to manufacturing tolerances, or the like.

As an output value required for the battery pack BP increases, a larger number of battery modules BM are disposed, and thus, there may be a concern that a gap (i.e., dead space (DS) ) between the battery modules BM will increase further. This dead space (DS) causes a decrease in the energy density of the battery pack BP.

In addition, in a conventional battery pack BP, the battery cells (BC) may be stacked in a direction parallel to a lower plate of the battery pack BP (e.g., in a Y-axis direction). In this case, when an overall height (i.e., a length in a Z-axis direction) of the battery pack BP changes, it may be necessary to newly manufacture battery cells (BC) and battery modules BM having a corresponding height. This causes a decrease in the production efficiency of the battery pack BP.

Accordingly, a battery module having a structure that may effectively cope with battery packs having various sizes (heights) while having high energy density is required.

### SUMMARY OF INVENTION

### Technical Problem

The present disclosure has been made to solve at least some of the problems of the above-mentioned conventional art, and provides a battery module and a battery pack having a high energy density.

Additionally, the purpose of the present disclosure is to provide a structure that may quickly and efficiently manufacture battery modules and battery packs having various sizes.

### Solution to Problem

In order to achieve the purpose, in embodiments of the present disclosure, provided is a battery module including: a plurality of sub-modules disposed in a first direction; and one or more connecting members disposed between the plurality of sub-modules, and at least one of the plurality of sub-modules includes: a plurality of cell stacks disposed in the first direction; and a housing having an internal space in which the plurality of cell stacks are accommodated, and the plurality of cell stacks respectively include a plurality of battery cells stacked in a second direction, perpendicular to the first direction.

In embodiments, wherein the housing may include: an upper frame covering one side of at least one of the plurality of cell stacks; a lower frame covering the other side opposite to the one side of at least one of the plurality of cell stacks; and a cross frame connected to the upper frame and the lower frame and partitioning the internal space.

In embodiments, the plurality of cell stacks may include a first cell stack and a second cell stack disposed in the first direction, and the cross frame may be disposed between the first cell stack and the second cell stack.

In embodiments, the battery module may further include a protection member disposed on the cross frame and facing the first cell stack or the second cell stack.

In embodiments, the one or more connecting members may be coupled to at least one of the upper frame and the lower frame.

In embodiments, the one or more connecting members may include: a body portion facing at least one of the plurality of cell stacks; and

a flange portion extending in the first direction from an end of the body portion, and at least one of the upper frame and the lower frame is coupled to the flange portion.

In embodiments, at least one of the upper frame and the lower frame may include a step portion disposed between the flange portion and the cell stack.

In embodiments, at least a portion of the flange portion may be settled in and bonded to the step portion.

In embodiments, the one or more connecting members further includes a protection member fixed to the body portion and facing at least one of the plurality of cell stacks.

In embodiments, the one or more connecting members may further include: a flow path portion formed inside the body portion and allowing a cooling medium to flow therein.

In embodiments, the flow path portion may include a plurality of flow paths extending in a third direction, perpendicular to both the first direction and the second direction, and the plurality of flow paths may be arranged side by side in the second direction.

In embodiments, the plurality of sub-modules and the one or more connecting members may be disposed alternately in the first direction.

In embodiments, the battery module may further include a side cover coupled to one of the plurality of sub-modules and disposed on an outermost portion in the first direction.

In embodiments, the plurality of sub-modules may include a first sub-module and a second sub-module, the side cover may be connected to one end of the first sub-module, and one end and the other end of the second sub-module may be respectively connected to the connecting member.

In embodiments, the battery module may further include: a first bus-bar assembly electrically connected to a cell stack of the first sub-module; and a second bus-bar assembly electrically connected to a cell stack of the second sub-module, and the first bus-bar assembly and the second bus-bar assembly may be disposed side by side in the first direction.

In embodiments, the plurality of sub-modules may include a first sub-module in which the plurality of cell stacks are accommodated; and a third sub-module which is connected to the first sub-module and in which one cell stack is accommodated.

In embodiments, provided is a battery pack including: a plurality of battery modules; and a case in which the plurality of battery modules are accommodated, and at least one of the plurality of battery modules includes: a plurality of sub-modules disposed in a first direction; and one or more connecting members disposed between the plurality of sub-modules, and at least one of the plurality of sub-modules includes a plurality of cell stacks disposed in the first direction, and the plurality of cell stacks respectively include a plurality of battery cells stacked in a second direction, perpendicular to the first direction.

### Advantageous Effects of Invention

According to embodiments, a battery module and a battery pack having a high energy density may be implemented.

According to embodiments, battery modules and battery packs having various sizes may be manufactured quickly and efficiently by utilizing battery cells having the same size.

### BRIEF DESCRIPTION OF DRAWINGS

FIG. 1 is an exemplary diagram of a conventional battery pack.

FIG. 2 is a schematic cross-sectional view taken along line I-I′ of FIG. 1.

FIG. 3 is a perspective view of the battery module.

FIG. 4 is an exploded perspective view of a battery module.

FIG. 5 shows a cell stack and a housing included in a sub-module.

FIG. 6 is a perspective view of a battery cell included in a battery module.

FIG. 7 illustrates a state in which a connecting member and a side cover are coupled to a housing of a sub-module.

FIG. 8 illustrates a state in which a flow path portion is formed in a connecting member.

FIG. 9 is a schematic cross-sectional view taken along line II-II′ of FIG. 3.

FIG. 10 is a schematic cross-sectional view of a battery module including three or more sub-modules.

FIG. 11 is a schematic cross-sectional view of a battery module according to other embodiments.

FIG. 12 illustrates a state in which a plurality of battery modules are accommodated in a battery pack.

FIG. 13 is a schematic cross-sectional view taken along line III-III′ of FIG. 12.

### DETAILED DESCRIPTION

Prior to describing the exemplary embodiments in detail, it should be understood that the terms used in the specification and the appended claims should not be construed as being limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

The same reference numeral or symbol written in each accompanying drawing of the specification refers to parts or components that perform substantially the same function. The present inventive concept is described using the same reference numeral or symbol even in different exemplary embodiments for easy description and appreciation. In this aspect, although all components having the same reference numeral are illustrated in a plurality of drawings, the plurality of drawings do not necessarily refer to a single exemplary embodiment.

In this specification, the singular also includes the plural unless specifically stated otherwise in the phrase. It will be further understood that the terms “comprises,” “comprising,” “includes” “including”, when used herein, specify the presence of stated features, integers, steps, operations, elements, components and/or combinations thereof, but do not preclude the presence or addition of one or more other features, integers, steps, operations, elements, components, and/or groups thereof.

In addition, it should be noted in advance that the expressions such as “above,” “upper,” “below”, “beneath,” “lower,” “side,” “front,” and “rear” are based on the direction illustrated in the drawings, and may be expressed differently if the direction of the object is changed.

In addition, in the present specification and claims, terms including ordinal numbers such as “first” and “second” may be used to distinguish between components. These ordinal numbers are used to distinguish the same or similar components from each other, and the meaning of the terms should not be construed as limited by the use of these ordinal numbers. For example, the components combined with these ordinal numbers should not be construed as limiting the order of use or arrangement of the components. If necessary, the ordinal numbers may be used interchangeably.

Hereinafter, with reference to the drawings, specific embodiments of the present disclosure will be described. However, the scope of the present disclosure is not limited to the suggested embodiments. For example, those skilled in the art who understand the idea of the present disclosure may propose other embodiments included within the scope of the idea of the present disclosure by adding, modifying, or deleting components, but the embodiments described herein have been provided so that this disclosure will be thorough and complete, and will convey the full scope of the disclosure to one of ordinary skill in the art. In the drawings, the shapes and dimensions of elements may be exaggerated for clarity.

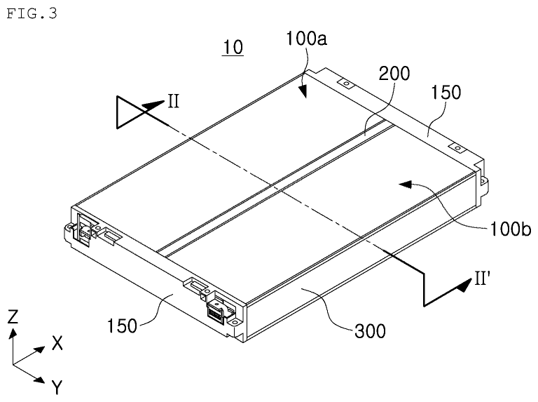

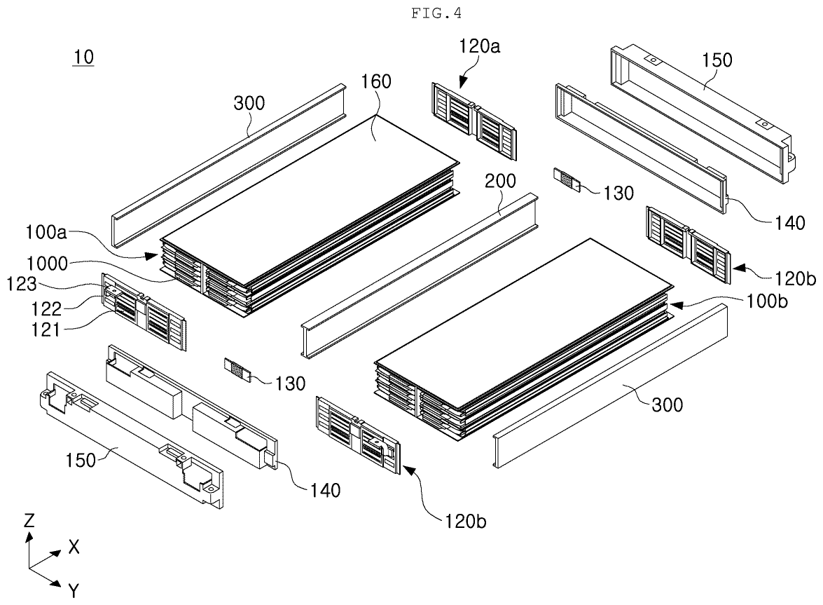

Hereinafter, a battery 10 according to embodiments will be described with reference to FIGS. 3 and 4. FIG. 3 is a perspective view of a battery module 10. FIG. 4 is an exploded perspective view of a battery module 10.

The battery module 10 may include a plurality of sub-modules 100 and a connecting member 200 connecting the sub-modules 100 to each other.

The battery module 10 may include the plurality of sub-modules 100. For example, the battery module 10 may include a first sub-module 100a and a second sub-module 100b arranged in one direction.

One or more connecting members 200 may be disposed between two of the plurality of sub-modules 100. For example, referring to FIG. 4, the connecting member 200 may r be disposed between the two sub-modules 100 disposed side by side in a first direction (Y-axis direction).

A plurality of sub-modules 100 may be connected to each other via a connecting member 200. For example, the first sub-module 100a may be connected to one side of a connecting member 200, and the second sub-module 100b may be connected to the other side of a connecting member 200, so that the first sub-module 100a and the second sub-module 100b may be connected to each other via the connecting member 200.

The connecting member 200 may include a material having a predetermined rigidity in order to connect and stably support the plurality of sub-modules 100. For example, the connecting member 200 may include a metallic material such as aluminum or stainless steel.

In embodiments, the plurality of sub-modules 100 may be connected to each other via the connecting member 200 to form one battery module 10. In FIG. 4, only two sub-modules (i.e., the first sub-module 100a and the second sub-module 100b) are illustrated, but the number of sub-modules 100 included in one battery module 10 may be three or more. In this case, a plurality of connecting members 200 may also be provided by corresponding to the number of sub-modules 100. For example, the battery module 10 may include N sub-modules 100 and N-1 connecting members 200. The plurality of sub-modules 100 and the plurality of connecting members 200 may be alternately disposed and connected in the first direction (Y-axis direction) to form at least a portion of the entire battery module 10.

The manufacturer may determine the number of sub-modules 100 according to a power value required for the battery module 10 and may manufacture the battery module 10 by connecting the sub-modules 100 to each other through the connecting member 200. Accordingly, the manufacturer may quickly and easily manufacture battery modules 10 having various sizes and types.

The battery module 10 may further include a side cover 300 coupled to at least one of the plurality of sub-modules 100. The side cover 300 may be disposed on an outermost portion of the battery module 10 in the first direction (Y-axis direction) to form a side surface of the battery module 10.

The side cover 300 may be spaced apart from the connecting member 200 in the first direction (Y-axis direction). At least one of the plurality of sub-modules 100 may be coupled to the side cover 300 and the connecting member 200, respectively. For example, referring to FIG. 4, the connecting member 200 may be coupled to one side of the first sub-module 100a in the first direction (Y-axis direction), and the side cover 300 may be coupled to the other side of the first sub-module 100a in the first direction (Y-axis direction).

Similarly to the connecting member 200, the side cover 300 may include a material having a predetermined rigidity to protect the battery module 10. For example, the side cover 300 may include a metallic material such as aluminum or stainless steel.

One sub-module 100 may include a cell stack 110 including battery cells 1000 stacked in a second direction (e.g., Z-axis direction), perpendicular to the first direction (Y-axis direction), a housing 160 in which the cell stack 110 is accommodated, and a busbar assembly 120 electrically connected to the cell stack 110.

The cell stack 110 may include a plurality of battery cells 1000 electrically connected to each other. The battery cells 1000 of the cell stack 110 may be connected to each other in series or in parallel, thereby storing or outputting electrical energy.

The busbar assembly 120 may include a plurality of busbars 121 electrically connecting the battery cells 1000 of the cell stack 110 and a busbar frame 122 supporting the busbars 121.

The busbar assembly 120 may be disposed on at least one side of the cell stack 110. For example, referring to FIG. 4, the busbar assembly 120 may be disposed to face the cell stack 110 in a third direction (for example, the X-axis direction). Here, the third direction (the X-axis direction) may be a direction, perpendicular to both the first direction (the Y-axis direction) and the second direction (the Z-axis direction).

The busbar 121 may be formed of a conductive material and may serve to electrically connect a plurality of battery cells 1000 to each other. The busbar 121 may be electrically connected to the battery cells 1000 in a state in which the busbar 121 is fixed to the busbar frame 122. A terminal t portion 123 may be disposed in at least some of the busbars 121. One sub-module 100 may be electrically connected to another neighboring sub-module 100 or an external circuit through the terminal portion 123.

The busbar frame 122 may support the busbar 121 to be stably connected to the battery cell 1000. The busbar frame 122 may include a non-conductive material (e.g., plastic) having a predetermined rigidity, and may structurally supports a plurality of busbars 121.

The battery module 10 may include the plurality of busbar assemblies 120 corresponding to the plurality of sub-modules 100, respectively. For example, the first sub-module 100a may include a first busbar assembly 120a, and the second sub-module 100b may include a second busbar assembly 120b, and the first busbar assembly 120a and the second busbar assembly 120b may be separated from each other and disposed side by side in the first direction (Y-axis direction). However, this is only an example, and the battery module 10 may also include an integral busbar assembly connected to both of two or more sub-modules 100.

The plurality of busbar assemblies 120a and 120b may be electrically connected to each other through a connecting conductor 130. For example, referring to FIG. 4, the battery module 10 may include the connecting conductor 130 electrically connecting the first busbar assembly 120a and the second busbar assembly 120b to each other.

The connecting conductor 130 may be disposed to face the connecting member 200 in the third direction (X-axis direction). However, an arrangement position of the connecting conductor 130 is not limited thereto.

The battery module 10 may include an insulating cover 140 covering at least one surface of the busbar assembly 120. The insulating cover 140 may include a non-conductive material, thereby preventing the busbar 121 of the busbar assembly 120 from being unintentionally short-circuited with another component.

The insulating cover 140 may face the busbar assembly 120 in the third direction (X-axis direction), perpendicular to the first direction (Y-axis direction).

An end cover 150 may be disposed on an outermost portion on one side of the battery module 10. The end cover 150 may include a material having rigidity (e.g., a metallic material such as aluminum) to protect the battery module 10 from external impact.

As illustrated in FIG. 4, the insulating cover 140 or the end cover 150 may be an integral member that may cover all of the sub-modules 100. However, this is only an example, and the insulating cover 140 and the end cover 150 may each be provided in plural and may be formed to individually cover the sub-modules 100.

Based on one sub-module 100, the end cover 150, the connecting member 200 and the side cover 300 may cover different surfaces of the sub-module 100. For example, referring to FIG. 4, one surface of the first sub-module 100a in the first direction (Y-axis direction) may be covered with the side cover 300, the other surface of the first sub-module 100a in the first direction (Y-axis direction) may be covered with the connecting member 200, and both surfaces of the first sub-module 100a in the third direction (X-axis direction) may be covered with the insulating cover 140 and the end cover 150.

In one battery module 10, the plurality of sub-modules 100 may be electrically connected to each other so as to output a design power value required for the battery module 10. For example, the two sub-modules 100 facing each other with a connecting member 200 interposed therebetween may be connected to each other in series or in parallel through the connecting conductor 130.

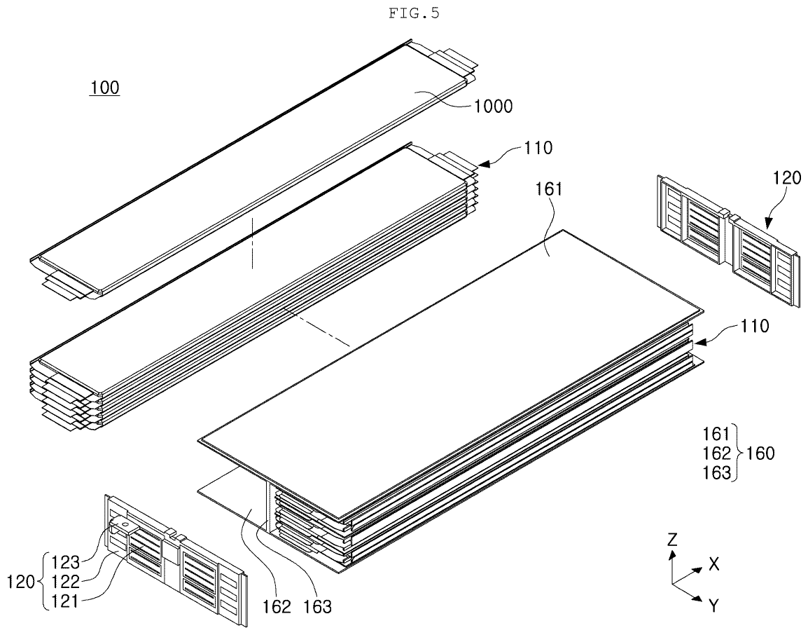

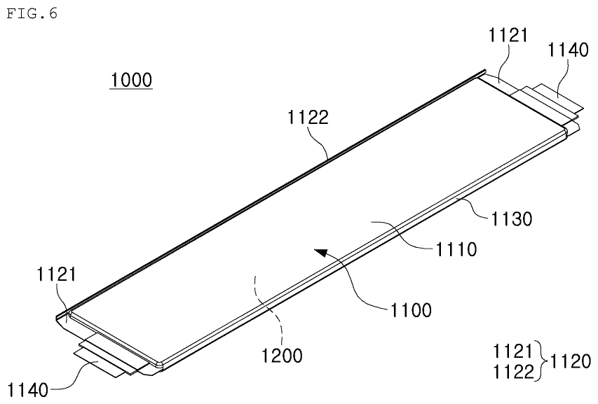

Hereinafter, with reference to FIGS. 5 and 6, the cell stack 110 included in the sub-module 100 will be described in detail.

FIG. 5 illustrates a cell stack 110 and a housing 160 included in a sub-module 100. FIG. 6 is a perspective view of a battery cell 1000 included in a battery module 10.

The battery cell 1000, the cell stack 110, and the sub-module 100 described in FIGS. 5 and 6 correspond to the battery cell 1000, the cell stack 110 and the sub-module 100 described in FIGS. 3 and 4, and thus, redundant descriptions thereof may be omitted.

The sub-module 100 may include a housing 160 having an internal space in which the cell stack 110 is accommodated.

Referring to FIG. 5, the housing 160 may include an upper frame 161 and a lower frame 162 spaced apart from each other in the second direction (Z-axis direction), perpendicular to the first direction (Y-axis direction). The internal space in which the cell stack 110 is accommodated may be formed between the upper frame 161 and the lower frame 162. When the cell stack 110 is disposed in the internal space, one side of the cell stack 110 may be covered with the upper frame 161, and the other side of the cell stack 110 may be covered with the lower frame 162.

The housing 160 may further include a cross frame 163 dividing the internal space into a plurality of accommodation spaces S1 and S2. Both ends of the cross frame 163 may be connected to the upper frame 161 and the lower frame 162, respectively. As the upper frame 161, the lower frame 162, and the cross frame 163 are connected to each other, the housing may have a frame structure in an ‘I’ shape (or, an ‘H’ shape).

The upper frame 161, the lower frame 162, and the cross frame 163 may be formed integrally with each other, or may be formed as separate members and mutually coupled.

In the housing 160, a plurality of accommodation spaces S1 and S2 may be arranged in the first direction (Y-axis direction). For example, the first accommodation space S1 may be formed on one side of the first direction (Y-axis direction) based on the cross frame 163, and the second accommodation space S2 may be formed on the other side of the first direction (Y-axis direction) based on the cross frame 163.

The plurality of accommodation spaces S1 and S2 may have an open form in the first direction (Y-axis direction). For example, the first accommodation space SI may have a form open to one side (Y-axis negative direction) in the first direction, and the second accommodation space S2 may have a form open to the other side (Y-axis positive direction) in the first direction.

Each of the accommodation spaces S1 and S2 may accommodate one or more cell stacks 110. Referring to FIG. 5, the cell stack 110 may include a first cell stack 111 accommodated in the first accommodation space S1 and a second cell stack 112 accommodated in the second accommodation space S2. Here, the first cell stack 111 and the second cell stack 112 may be arranged in the first direction (Y-axis direction) with the cross frame 163 interposed therebetween. In FIG. 5, one cell stack 110 is illustrated as being accommodated in each of the accommodation spaces S1 and S2, but this is only an example, and a plurality of cell stacks 110 may be accommodated in one accommodation space S1 or S2.

In order to increase the heat dissipation efficiency of the battery module 10, at least a portion of the housing 160 may be formed of a material having high thermal conductivity, such as a metal. For example, at least a portion of the upper frame 161, the lower frame 162 and the cross frame 163 may be formed of aluminum with excellent thermal conductivity. Accordingly, the thermal energy generated by the cell stack 110 may be quickly released to the outside through the housing 160. However, a material of the housing 160 is not limited thereto, and any material may be used as long as the material has a rigidity sufficient to protect the cell stack 110 and has thermal conductivity.

The cell stack 110 accommodated in each of the accommodation spaces S1 and S2 may include a plurality of battery cells 1000 stacked in one direction. In the following description, a stacking direction of the plurality of battery cells 1000 included in the cell stack 110 is referred to as a ‘cell stacking direction’.

The cell stacking direction of the cell stack 110 may be a direction, perpendicular to the first direction (Y-axis direction). For example, referring to FIG. 5, the first cell stack 111 and the second cell stack 112 may be arranged to face each other in the first direction (Y-axis direction) with the cross frame 163 interposed therebetween, each of which may also include a plurality of battery cells 1000 stacked in the second direction (Z-axis direction), perpendicular to the first direction (Y-axis direction). In this case, the cell stacking direction may be a direction parallel to a direction in which the upper frame 161 and the lower frame 162 face each other.

Alternatively, the cell stacking direction may be formed to be parallel to a gravity direction. For example, in FIG. 5, the stacking direction of the cell stack 110 may be parallel to a direction of gravity.

The battery cell 1000 included in the cell stack 110 may be a secondary battery. As an example, the battery cell 1000 may be formed of a lithium secondary battery, but the present disclosure is not limited thereto.

In embodiments, the battery cell 1000 may be a pouch type secondary battery including a cell body portion 1110 and a sealing portion 1120 as illustrated in FIG. 6.

In the pouch type secondary battery, an electrode assembly 1200 and an electrolyte (not illustrated) may be stored inside a pouch 1100 formed by forming one or more casings. For example, after forming one or two storage portions on a single sheet of casing, the casing may be folded so that the storage portions form one space, thereby forming a pouch 1100.

The pouch 1100 may include a cell body 1110 including an electrode assembly 1200 and an electrolyte (not illustrated), a sealing portion 1120 formed around the cell body 1110, and an electrode lead 1140 electrically connected to the electrode assembly 1200 and exposed to the outside of the pouch 1100.

The cell body 1110 provides an internal space in which the electrode assembly 1200 and the electrolyte (not illustrated) are accommodated. The electrode assembly 1200 may have a form in which a plurality of positive electrode plates and a plurality of negative electrode plates are stacked with a separator interposed therebetween. The plurality of positive electrode plates and the plurality of negative electrode plates may be connected to different electrode leads 1140 by connecting the same polarities to each other. The electrode leads 1140 may be electrically connected to the bus bars 121 of the bus bar assembly 120.

The sealing portion 1120 formed by bonding the pouch 1100 may be disposed along at least a portion of a perimeter of the cell body portion 1110. The sealing portion 1120 may have a flange shape extending outwardly from the cell body portion 1110 formed in the shape of a container, and is disposed along an outer periphery of the cell body portion 1110. A thermal fusion method may be used for bonding the pouch 1100, but the present disclosure is not limited thereto.

The sealing portion 1120 may include a first sealing portion 1121 formed in a portion in which the electrode lead 1140 is disposed, and a second sealing portion 1122 formed in a portion in which the electrode lead 1140 is not disposed.

In order to increase the bonding reliability of the sealing portion 1120 and minimize an area of the sealing portion 1120, the battery cell 1000 may be formed in a form that is folded at least once. For example, the second sealing portion 1122 in which the electrode lead 1140 is not disposed may have a shape that is folded at least once.

When the battery cell 1000 has a structure in which a single sheet of casing is folded and wraps the electrode assembly 1200, there is no need to form the sealing portion 1120 in a portion in which the casing is folded. In this case, as illustrated in FIG. 6, the sealing portion 1120 may be formed on only three surfaces of an outer periphery of the cell body portion 1110, and a folding portion 1130 may be formed on one surface of the outer periphery of the cell body portion 1110. However, a structure of the battery cell 1000 is not limited to that illustrated. For example, the cell body portion 1110 may be formed by overlapping two casings, and the sealing portion 1120 may be formed on all four surfaces of the perimeter of the cell body portion 1110.

The battery cell 1000 according to example embodiments is not limited to a pouch-type secondary battery. For example, the battery cell 1000 may be formed as a square can-type secondary battery, and may also have a structure in which a plurality of pouch-type secondary batteries are grouped and formed into a bundle.

Although not illustrated in the drawing, the cell stack 110 may further include an insulating member (not illustrated) and a compression member (not illustrated) for protecting the battery cells 1000. The insulating member (not illustrated) and the compression member (not illustrated) may be stacked together with a plurality of battery cells 1000 in the second direction (Z-axis direction) to form at least a portion of the cell stack 110.

The insulating member (not illustrated) may prevent flame or high-temperature heat energy from being transmitted between neighboring battery cells 1000, thereby preventing a chain ignition phenomenon from occurring within the cell stack 110. For example, the insulating member (not illustrated) may include at least some of materials among mica, silica, silicate, graphite, alumina, ceramic wool, and aerogel, which may perform a heat and/or flame propagation prevention function.

The compression member (not illustrated) may be compressed and elastically deformed when a specific battery cell 1000 expands, and may thus suppress the expansion of an entire volume of the cell stack 110. For example, the compression member (not illustrated) may be formed of a polyurethane foam, and may have a size corresponding to a wide surface of the battery cell 1000. However, a material and size of the compression member (not illustrated) are not limited to those described above.

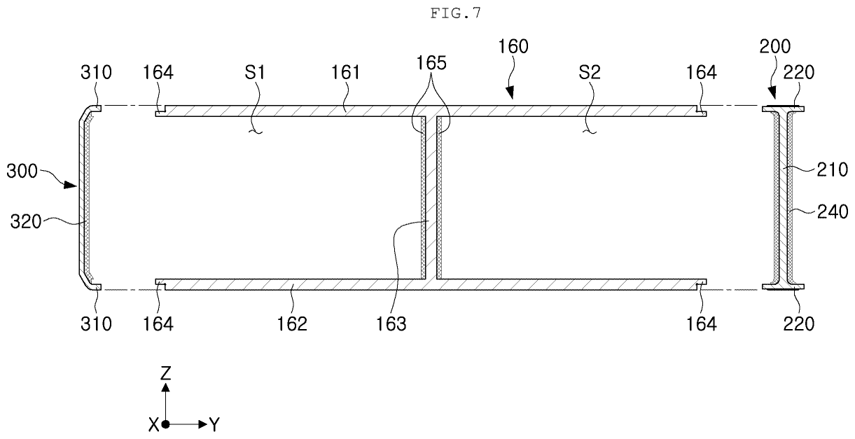

The sub-module 100 including the plurality of cell stacks 110 may be connected to another sub-module 100 through a connecting member 200 to form an entire battery module 10. Hereinafter, the connecting structure will be described in detail with reference to FIGS. 7 to 9.

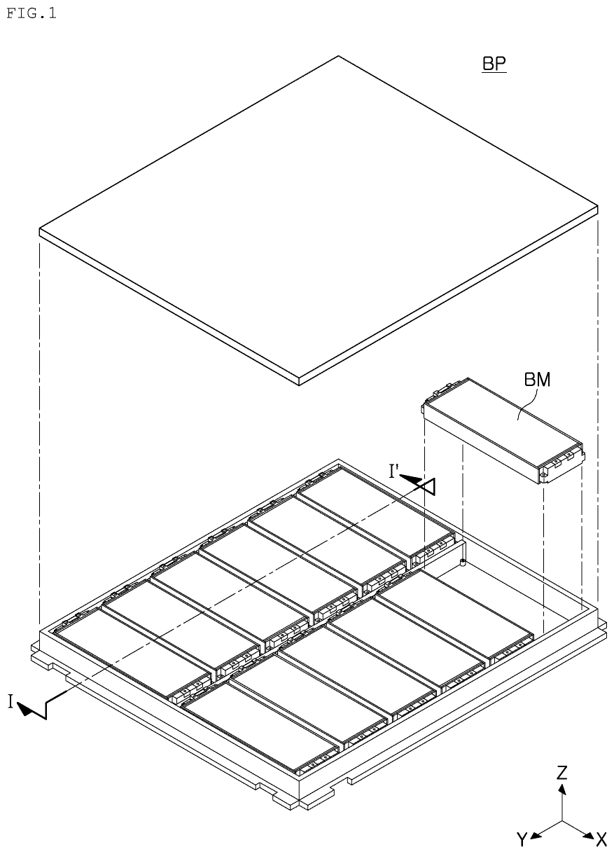

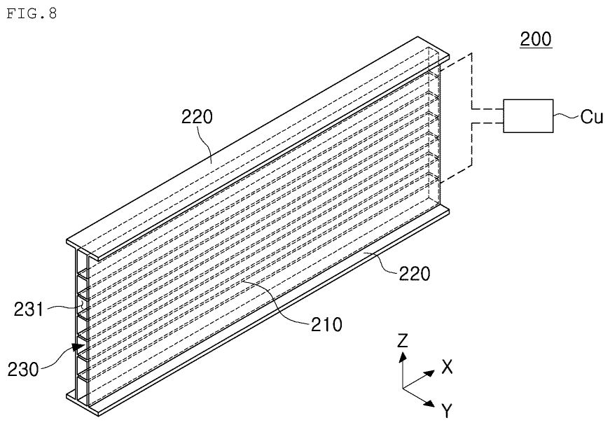

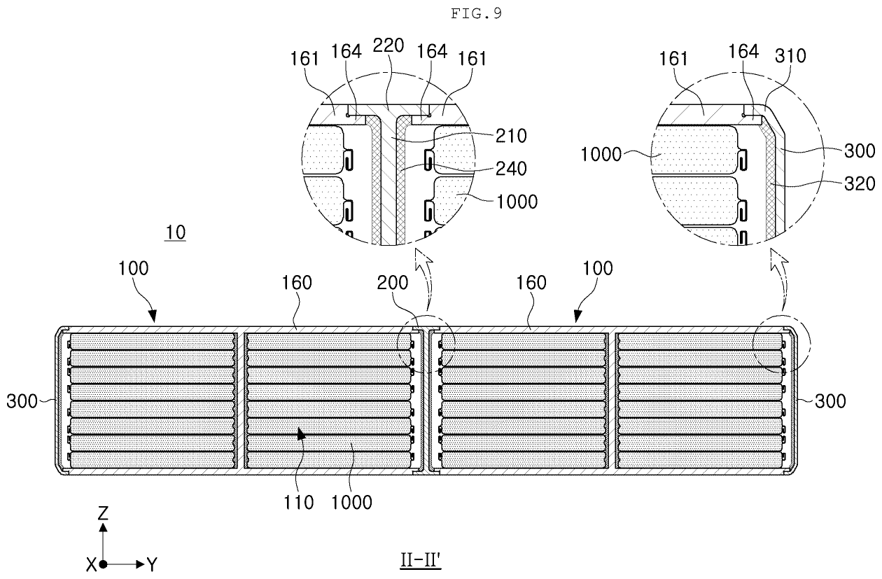

FIG. 7 illustrates a state in which a connecting member 200 and a side cover 300 are coupled to a housing 160 of a sub-module 100. FIG. 8 illustrates a state in which a flow path portion is formed in the connecting member 200. FIG. 9 is a schematic cross-sectional view taken along line II-II′ of FIG. 3. Since the housing 160, the side cover 300, and the connecting member 200 described in FIGS. 7 to 9 correspond to the housing 160, the side cover 300, and the connecting member 200 described in FIGS. 1 to 5, redundant descriptions thereof may be omitted.

The housing 160 of the sub-module 100 may include an upper frame 161 and a lower frame 162 spaced apart from each other, and a cross frame 163 connecting the upper frame 161 and the lower frame 162. A space in which a plurality of cell stacks 110 may be accommodated may be formed between the upper frame 161 and the lower frame 162, and the cross frame 163 may partition the space into a first accommodation space S1 and a second accommodation space S2.

The housing 160 of the sub-module 100 may be coupled to the connecting member 200 and the side cover 300. For example, referring to FIG. 7, the side cover 300 may be coupled to one side of the first sub-module 100a, and the connecting member 200 may be coupled to the other side opposite to the one side.

Alternatively, the connecting member 200 may be coupled to both sides of one sub-module 100 included in the battery module 10. For example, in a structure in which three or more sub-modules 100 are connected on a line via the connecting members 200, the connecting members 200 may be disposed on each side of the sub-module 100 disposed therebetween.

The connecting member 200 may include a body portion 210 and a flange portion 220 formed in an end of the body portion 210.

The body portion 210 is a portion extending from the connecting member 200 in the second direction (Z-axis direction), a height direction of the sub-module 100, and forms a body of the connecting member 200. In a state in which the connecting member 200 is coupled with the sub-module 100, the body portion 210 may face one side of the cell stack 110.

A first protection member 240 may be disposed on at least one surface of the body portion 210. The first protection member 240 may include a material capable of performing a heat dissipation function, a cooling function, or a heat blocking function.

For example, the first protection member 240 may include at least some of materials including mica, silica, silicate, graphite, alumina, ceramic wool, and aerogel, and may block thermal energy generated by one sub-module (e.g., 100a) from being transmitted to another neighboring sub-module (e.g., 100b).

Alternatively, the first protection member 240 may include a material having excellent thermal conductivity, and may help heat to be quickly transmitted from the cell stack 110 to the connecting member 200. Accordingly, thermal energy generated by the cell stack 110 may be quickly released to the outside of the battery module 10 through the connecting member 200.

A flange portion 220 may be a portion formed to be wider than a width of the body portion 210 in upper and lower ends of the body portion 210.

In a coupling structure of the connecting member 200 and the housing 160, the housing 160 may include a step portion 164 engaging with the flange portion 220 of the connecting member 200. For example, referring to FIGS. 7 and 9, the step portion 164 in which a width thereof narrows may be provided in one end of the upper frame 161 of the housing 160, and at least a portion of the flange portion 220 may be engaged with and coupled to the step portion 164. Additionally, the step portion 164 in which a width thereof narrows may also be provided in one end of the lower frame 162 of the housing 160, and at least a portion of the flange portion 220 may be engaged with and coupled to the step portion 164.

The flange portion 220 may have a shape extending from the end of the body portion 210 in both sides in the first direction (Y-axis direction), and accordingly, one side of the flange portion in the first direction (Y-axis direction) may be coupled to the first sub-module 100a, and the other side of the flange portion in the first direction (Y-axis direction) may be coupled to the second sub-module 100b.

The connecting member 200 may be welded to the housing 160 in a state in which the flange portion 220 is settled in the step portion 164 of the housing 160, and thus the connecting member 200 and the housing 160 may be firmly coupled to each other.

The step portion 164 of the housing 160 and the flange portion 220 may face each other in the second direction (Z-axis direction), a height direction of the housing 160. In this case, the flange portion 220 may be further disposed on an outer periphery in the second direction (Z-axis direction) than the step portion 164. For example, in a state in which the flange portion 220 and the step portion 164 are engaged with each other, the step portion 164 may be disposed between the cell stack 110 accommodated in the accommodation space of the housing 160 and the flange portion 220. According to this structure, the housing 160 may better withstand expansion pressure of the cell stack 110 occurring during a swelling phenomenon. Specifically, when the swelling phenomenon occurs in the cell stack 110 stacked in the second direction (Z-axis direction), the housing 160 may be subjected to the expansion pressure in the second direction (Z-axis direction), but the flange portion 220 may be engaged with the step portion 164, thereby preventing the housing 160 from opening in the second direction (Z-axis direction). Accordingly, the housing 160 may stably withstand the expansion pressure of the cell stack 110, and may prevent the cell stack 110 from swelling to a certain extent or more.

The side cover 300 may be coupled to the sub-module 100 to form a side surface of the battery module 10.

Similarly to the connecting member 200, the side cover 300 may have a structure engaged with the step portion 164 of the housing 160. For example, referring to FIG. 7, the side cover 300 may have a bent portion 310 formed by being bent toward the first direction (Y-axis direction), and the bent portion 310 may be engaged with and coupled to the step portion 164 of the housing 160.

The bent portion 310 of the side cover 300 may face the step portion 164 of the housing 160 in the second direction (Z-axis direction). In this case, the bent portion 310 of the side cover 300 may be further disposed on an outer periphery in the second direction (Z-axis direction) than the step portion 164. By this structure, the housing 160 may stably withstand the expansion pressure of the cell stack 110. For a specific description, reference may be made to the description of the coupling structure between the flange portion 220 of the connecting member 200 and the step portion 164 of the housing 160.

Similarly to the connecting member 200, the side cover 300 may be welded to the housing 160 in a state in which the side cover 300 is engaged with the step portion 164 of the housing 160.

A second protection member 320 may be disposed on an inner surface of the side cover 300. The second protection member 320 may face the cell stack 110 accommodated in the housing 160 in the first direction (Y-axis direction). The second protection member 320 may be formed of the same material as the first protection member 240 and may perform the same function.

Additionally, a third protection member 165 may be disposed on at least a portion of an inner surface of the housing 160. For example, referring to FIG. 7, the third protection member 165 may be disposed on a portion of the cross frame 163 facing the cell stack 110. Here, the third protection member 165 may be formed of the same material as the first protection member 240 or the second protection member 320 and may perform the same function.

In embodiments, a flow path portion 230 through which a cooling medium (e.g., cooling water) may flow may be disposed on the connecting member 200. For example, referring to FIG. 8, the flow path portion 230 may be disposed within the body portion 210 of the connecting member 200, and as the cooling medium flows along the flow path portion 230, the cooling medium may absorb heat energy generated by the cell stack 110 and may cool the battery module 10.

The flow path portion 230 may have one or more flow paths 231 through which a cooling medium may flow inside. As illustrated in FIG. 8, the flow path 231 of the flow path portion 230 may be formed as a tubular flow path extending in the third direction (X-axis direction) inside the body portion 210, but a specific shape thereof is not limited to that illustrated in the drawing.

The flow path portion 230 may be formed of a plurality of layers in an extension direction of the body portion 210 ( for example, the second direction (Z-axis direction)), and the cooling medium may flow sequentially or simultaneously through at least some of the plurality of layers, thus cooling the battery module 10.

The cooling medium may flow along the flow path portion 230 by a refrigerant circulation unit CU. The refrigerant circulation unit CU may supply a cooling medium to the flow path portion 230, or recover the cooling medium in which heat exchange has been completed, thus circulating the cooling medium.

The connecting member 200 may be disposed between the sub-modules 100 to prevent heat transmission between neighboring sub-modules 100. Specifically, when the flow path portion 230 is disposed in the connecting member 200, since the cooling medium flows between the sub-modules 100 and the sub-modules 100, heat transmission between the sub-modules 100 may be more reliably blocked, thereby increasing the cooling efficiency of the battery module 10.

However, the connecting member 200 may also be manufactured as a simple beam-shaped structure without the flow path portion as illustrated in FIG. 8.

The battery module 10 according to example embodiments has a structure in which a plurality of sub-modules 100 respectively including cell stacks 110 stacked in the second direction (Z-axis direction) are arranged in a first direction (Y-axis direction), and accordingly, a plurality of battery cells 1000 may be intensively disposed in a limited space of the battery module 10, and a large-capacity battery module 10 may be implemented.

In addition, by means of the structure, battery modules 10 having various sizes may be manufactured quickly and efficiently.

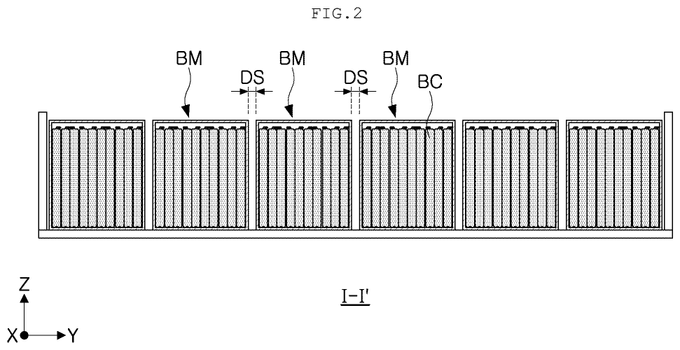

In a conventional battery module (e.g., BM of FIGS. 1 and 2), when a design height (e.g., a length in the Z-axis direction) required for the battery module BM is changed, a battery cell (e.g., BC of FIGS. 1 and 2) having a corresponding size should be newly manufactured.

On the other hand, in a case of the battery module 10 according to example embodiments, since a height of the cell stack 110 may be appropriately adjusted by changing the number of battery cells 1000 to be stacked, battery modules 1000 having various heights may be manufactured by utilizing already manufactured battery cells 1000.

Additionally, when a width (e.g., a length in the Y-axis direction) required for the battery module 10 is changed, since the number of connected sub-modules 100 may be appropriately adjusted to respond to the change, the manufacturing efficiency of the battery module 10 may be increased.

Hereinafter, battery modules having various sizes and structures formed by combining the above-described sub-modules and connecting members will be described.

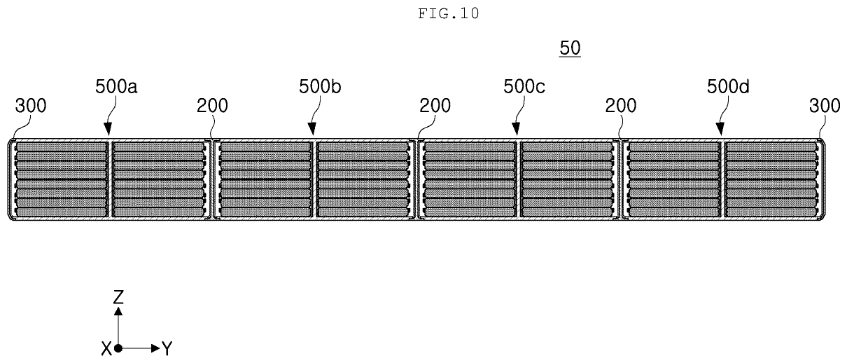

FIG. 10 is a schematic cross-sectional view of a battery module 50 including three or more sub-modules 500. Referring to FIG. 10, the battery module 50 may include first to fourth sub-modules 500a, 500b, 500c and 500d connected to each other via connecting members 200.

At least one of the first to fourth sub-modules 500a, 500b, 500c and 500d may correspond to the sub-module 100 described above in FIG. 5. That is, at least one of the first to fourth sub-modules 500a, 500b, 500c and 500d may include two or more cell stacks (e.g., 110 in FIG. 5) arranged in a first direction (Y-axis direction) with a cross frame (e.g., 163 in FIG. 5) interposed therebetween, and in this case, each of the cell stacks 110 may include a plurality of battery cells (e.g., 1000 in FIG. 5) stacked in the second direction (Z-axis direction), perpendicular to the first direction (Y-axis direction). For the specific structure of the sub-module 500, reference may be made to FIG. 5, and redundant descriptions thereof will be omitted.

The first to fourth sub-modules 500a, 500b, 500c and 500d may be arranged in the first direction (Y-axis direction) and may be connected to each other. Between any two sub-modules 500, the connecting member 200 may be disposed to connect the sub-modules 500 to each other. Meanwhile, a side cover (for example, 300 of FIG. 4) may be coupled to the first sub-module 500a and the fourth sub-module 500d disposed on an outermost portion in the first direction (Y-axis direction).

In the battery module 50 illustrated in FIG. 10, since the coupling structure described in FIGS. 7 to 9 may be applied to a coupling structure between the first to fourth sub-modules 500a, 500b, 500c and 500d and the connecting member 200 and a coupling structure between the first and fourth sub-modules 500a, 500d and the side cover 300, redundant descriptions thereof will be omitted.

In FIG. 10, a structure in which the four sub-modules 500a, 500b, 500c and 500d are coupled is illustrated, but this is only an example, and a battery module 50 may also be formed by interconnecting five or more sub-modules.

In this manner, the plurality of sub-modules 500a, 500b, 500c and 500d may be sequentially connected to each other using the connecting member 200 to form an entire battery module 50, and thus, a high-capacity battery module 50 having high energy density may be implemented.

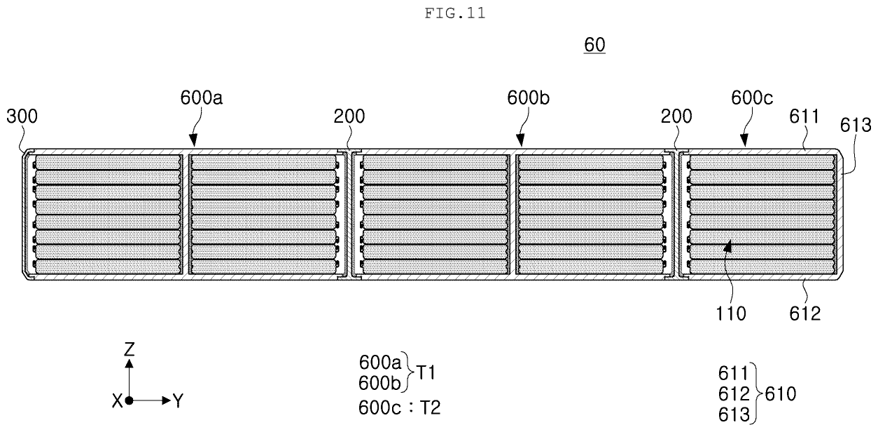

FIG. 11 is a schematic cross-sectional view of a battery module 60 according to other example embodiments. Referring to FIG. 11, the battery module 60 may include first to third sub-modules 600a, 600b and 600c connected to each other via the connecting members 200.

Here, the first and second sub-modules 600a and 600b may correspond to the sub-modules 100 described above in FIG. 5, and a detailed description of the structure thereof may be referred to FIG. 5.

The third sub-module 600c may have a different structure from the first and second sub-modules 600a and 600b. In order to identify and explain the sub-modules having different structures, a sub-module having the same structure as the first and second sub-modules 600a and 600b is defined as a first type sub-module T1, and a sub-module having the same structure as the third sub-module 600c is defined as a second type sub-module T2.

A housing 610 of the third sub-module 600c may have a structure in which one cell stack (for example, 110 of FIG. 5) is accommodated. For example, referring to FIG. 11, the housing 610 of the third sub-module 600c may include an upper frame 611 and a lower frame 612 spaced apart from each other in a second direction (Z-axis direction), a stacking direction of the cell stack 110, and a side frame 613 facing the cell stack 110 in the first direction (Y-axis direction).

One side of the upper frame 611 and the lower frame 612 may be coupled to a connecting member 200, and the other side of the upper frame 611 and the lower frame 612 may be connected to the side frame 613. For example, the housing 610 of the third sub-module 600c may have a cross-sectional structure in a ‘U’ shape that is open in a direction oriented toward the connecting member 200.

The third sub-module 600c may accommodate one cell stack 110, and thus, the battery module may have a structure in which an odd number of cell stacks 110 are accommodated. Here, regarding a specific description of each cell stack 110, reference may be made to the cell stack 110 of FIG. 5.

The connecting member 200 may be disposed and coupled between the first sub-module 600a and the second sub-module 600b and between the second sub-module 600b and the third sub-module 600c, and accordingly, the first to third sub-modules 600a, 600b and 600c may be connected to each other in the first direction (Y-axis direction), thus forming the entire battery module 60.

The side cover 300 may be coupled to the first sub-module 600a disposed on an outermost portion on one side in the first direction (Y-axis direction). On the other hand, the side cover 300 does not need to be coupled to the third sub-module 600c disposed on an outermost portion on other side in the first direction (Y-axis direction). That is, the side frame 613 of the third sub-module 600c is exposed to the outside in the outermost portion on other side of the first direction (Y-axis direction), thus forming a side surface of the battery module 60.

Meanwhile, the coupling structure described in FIGS. 7 to 9 may be applied to a coupling structure between the connecting member 200 and the sub-modules 600a, 600b and 600c and a coupling structure between the side cover 300 and the first sub-module 600a, and redundant descriptions thereof will be omitted.

In FIG. 11, a structure in which two first type sub-modules Tl and one second type sub-module T2 are coupled is illustrated, but this is only an example, and the battery module may also be formed by connecting one or more first type sub-modules T1 and one second type sub-module T2 to each other.

Additionally, unlike that as illustrated in FIG. 11, the second type sub-modules T2 may be disposed on the outermost portions on both sides of the battery module in the first direction (Y-axis direction), and one or more first type sub-modules T1 may be disposed therebetween. In this case, both sides of the battery module in the first direction (Y-axis direction) may be formed by the side frame 613 of the second type sub-module T2.

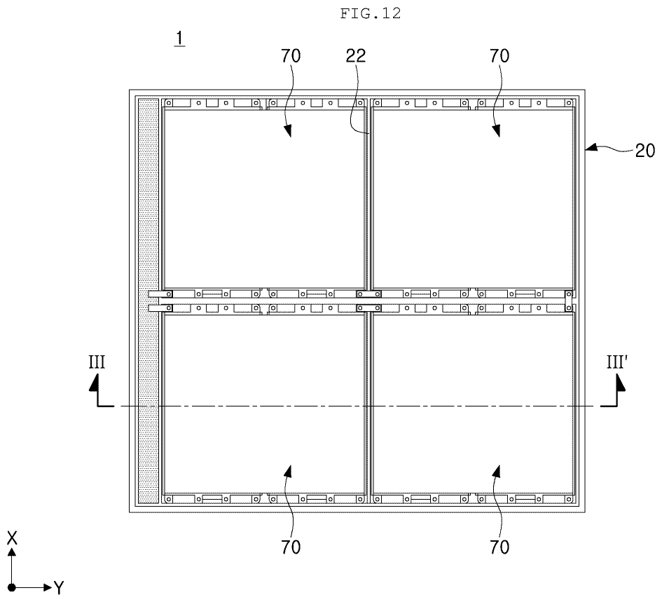

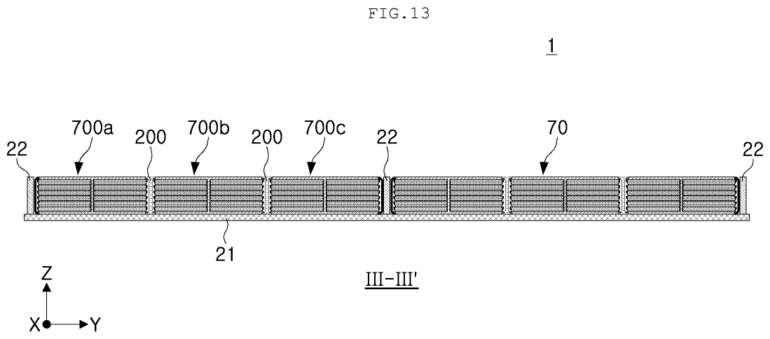

A plurality of battery modules may be interconnected to form at least a portion of a battery pack. Hereinafter, with reference to FIGS. 12 and 13, a battery pack 1 including a plurality of battery modules 70 will be described.

FIG. 12 illustrates a battery pack 1 in which a plurality of battery modules 70 are accommodated. FIG. 13 is a schematic cross-sectional view taken along line III-III′ of FIG. 12.

The battery module 70 described in FIGS. 12 and 13 may correspond to any one of the battery modules 10, 50, or 60 described in FIGS. 1 to 11, and thus, redundant descriptions thereof will be omitted.

The battery pack 1 may include a plurality of battery modules 70. For example, the plurality of battery modules 70 may be settled and fixed on a lower surface 21 of a case 20.

The battery module 70 included in the battery pack 1 may include a plurality of sub-modules. For example, referring to FIG. 13, one battery module 70 may include first to third sub-modules 700a, 700b and 700c connected in the first direction (Y-axis direction) via the connecting member 200. Here, at least one of the first to third sub-modules 700a, 700b and 700c may correspond to the sub-module 100 described in FIG. 5, respectively. Alternatively, at least one of the first to third sub-modules 700a, 700b and 700c may correspond to the third sub-module 600c described in FIG. 11.

The battery pack 1 may include a support frame 22 disposed between the battery modules 70 and structurally supporting the battery pack 1. For example, the battery pack 1 may include a support frame 22 disposed between the battery modules 70 and extending in a height direction (e.g., the Z-axis direction) of the battery pack 1 from the lower surface 21.

The battery pack 1 including the battery module 70 according to example embodiments may have a higher energy density than that of a battery pack BP adopting a conventional battery module structure (e.g., the battery module BM of FIGS. 1 and 2).

Specifically, according to example embodiments, since a plurality of sub-modules are interconnected via the connecting member 200 to form an entire battery module 70, it may be possible to implement a single module structure that is structurally stable while including a large number of battery cells. Accordingly, the number of battery modules 70 accommodated in the battery pack 1 may be reduced, and thus, a dead space G1 formed between the battery modules 70 may be reduced.

Additionally, since the battery module 70 is able to increase module rigidity through the connecting member 200 disposed between the sub-modules, the support frame 22 of the case 20 may be omitted, or the number of support frames 22 may be reduced. As the number of support frames is reduced, a dead space G2 generated between the battery module 70 and the support frame 22 may also be naturally reduced.

In this manner, the battery pack 1 including the battery module 70 according to example embodiments may have a high energy density because the battery pack 1 is able to minimize the dead space G1 or G2 inside the case 20.

Additionally, according to example embodiments, the battery modules 70 having various sizes may be manufactured by changing the stacking quantity of battery cells, and thus, even if the design size of the battery pack 1 changes, a battery module 70 suitable for the design size may be manufactured quickly and efficiently.

Although various embodiments of the disclosed technology have been described in detail above, the scope of the disclosed technology is not limited thereto, and it will be apparent to those skilled in the art that modifications and variations could be made without departing from the scope of the disclosed technology as defined by the appended claims. In addition, some components may be deleted and implemented in the above-described example embodiments, and each of the embodiments may be combined and implemented with each other.

1. A battery module, comprising:
a plurality of sub-modules disposed in a first direction; and
one or more connecting members disposed between the plurality of sub-modules,
wherein at least one of the plurality of sub-modules includes:
a plurality of cell stacks disposed in the first direction; and
a housing having an internal space in which the plurality of cell stacks are accommodated,
wherein the plurality of cell stacks respectively include a plurality of battery cells stacked in a second direction, perpendicular to the first direction.

2. The battery module of claim 1, wherein the housing includes:
an upper frame covering one side of at least one of the plurality of cell stacks;
a lower frame covering the other side opposite to the one side of at least one of the plurality of cell stacks; and
a cross frame connected to the upper frame and the lower frame and partitioning the internal space.

3. The battery module of claim 2, wherein the plurality of cell stacks include a first cell stack and a second cell stack disposed in the first direction, and
the cross frame is disposed between the first cell stack and the second cell stack.

4. The battery module of claim 3, further comprising:
a protection member disposed on the cross frame and facing the first cell stack or the second cell stack.

5. The battery module of claim 2, wherein the one or more connecting members are coupled to at least one of the upper frame and the lower frame.

6. The battery module of claim 5, wherein the one or more connecting members include:
a body portion facing at least one of the plurality of cell stacks; and
a flange portion extending in the first direction from an end of the body portion,
wherein at least one of the upper frame and the lower frame is coupled to the flange portion.

7. The battery module of claim 6, wherein at least one of the upper frame and the lower frame includes a step portion disposed between the flange portion and the cell stack.

8. The battery module of claim 7, wherein at least a portion of the flange portion is settled in and bonded to the step portion.

9. The battery module of claim 6, wherein the one or more connecting members further includes:
a protection member fixed to the body portion and facing at least one of the plurality of cell stacks.

10. The battery module of claim 6, wherein the one or more connecting members further includes:
a flow path portion formed inside the body portion and allowing a cooling medium to flow therein.

11. The battery module of claim 10, wherein the flow path portion includes a plurality of flow paths extending in a third direction, perpendicular to both the first direction and the second direction, and
the plurality of flow paths are arranged side by side in the second direction.

12. The battery module of claim 1, wherein the plurality of sub-modules and the one or more connecting members are disposed alternately in the first direction.

13. The battery module of claim 12, further comprising:
a side cover coupled to one of the plurality of sub-modules and disposed on an outermost portion in the first direction.

14. The battery module of claim 13, wherein the plurality of sub-modules include a first sub-module and a second sub-module,
the side cover is connected to one end of the first sub-module, and
one end and the other end of the second sub-module are respectively connected to the connecting member.

15. The battery module of claim 14, further comprising:
a first bus-bar assembly electrically connected to a cell stack of the first sub-module; and
a second bus-bar assembly electrically connected to a cell stack of the second sub-module,
wherein the first bus-bar assembly and the second bus-bar assembly are disposed side by side in the first direction.

16. The battery module of claim 13, wherein the plurality of sub-modules include a first sub-module in which the plurality of cell stacks are accommodated; and
a third sub-module which is connected to the first sub-module and in which one cell stack is accommodated.

17. A battery pack, comprising:
a plurality of battery modules; and
a case in which the plurality of battery modules are accommodated,
wherein at least one of the plurality of battery modules includes:
a plurality of sub-modules disposed in a first direction; and
one or more connecting members disposed between the plurality of sub-modules,
wherein at least one of the plurality of sub-modules includes a plurality of cell stacks disposed in the first direction, and
the plurality of cell stacks respectively include a plurality of battery cells stacked in a second direction, perpendicular to the first direction.
